(19) United States
(12) Patent Application Publication
(10) Pub. No.: US 2010/0300086 A1
(43) Pub. Date: Dec. 2, 2010

(54) HYDRAULIC CONTROL ARRANGEMENT AND DISTRIBUTION VALVE SECTION

(75) Inventors: Peter Büttner, Lohr (DE); Martin Birk, Oslo (NO); Armin Stellwagen, Lohr (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 12/743,589

(22) PCT Filed: Nov. 14, 2008
(86) PCT No.: PCT/DE2008/001890

§ 371 Date: Aug. 12, 2010

(30) Foreign Application Priority Data
Nov. 19, 2007 (DE) 10 2007 055 377.5

(51) Int. Cl. F15B 11/042

(52) U.S. Cl. 60/420

(57) ABSTRACT

A hydraulic control arrangement and a method for pressure medium supply of hydraulic consumers are disclosed, comprising an LS pump which can be controlled by a pump regulator dependent on the highest load pressure of the consumers. The pressure medium volume flow to each consumer is adjusted using a metering aperture, wherein on controlling a consumer a higher pressure than the load pressure is signaled to the LS pump regulator, so that the LS pump is controlled according to the higher pressure rather than the low load pressure of said consumer.

### BACKGROUND OF THE INVENTION

The invention relates to a hydraulic control arrangement for pressure medium supply of hydraulic consumers, and to a distribution valve section for such a control arrangement.

Such hydraulic control arrangements are, for instance, used in mobile hydraulics. In forestry, for instance, machinery components carried by an all-terrain working equipment are used which are adapted to perform suboperations of timber harvesting such as felling, debranching, decorticating, collecting, depositing. So-called harvesters are used to separate the lumber from the stem, to debranch it, to cut it in, and to collect the lumber cut to size. A harvester head employed for this purpose and supported at a crane of the working equipment comprises grabs, feed rolls, and a saw for felling, moving, debranching, and cutting the lumber to size. All these components are actuated hydraulically, wherein the controlling is usually performed through a mobile control block of the working equipment.

Such a control arrangement is frequently designed as an LS system, wherein a load-sensing variable displacement pump is adjusted as a function of the highest load pressure of the simultaneously actuated hydraulic consumers by an LS pump regulator such that the pump pressure always ranges by a predetermined Δp above the highest load pressure of the consumers. The pressure medium volume flow to the individual consumers of the harvester head is adjusted via a respective distribution valve section of the mobile control block, wherein this distribution valve section usually comprises an adjustable metering aperture—formed by a proportionately adjustable distribution valve—and an LS or LUDV pressure compensation valve.

The harvester head of a forestry machine is a product equipped with many functions in which the device components required for the many functions are accommodated in a narrow space and are therefore to be dimensioned as small as possible. The hydraulic valves required for the control of the hydraulic consumers at a harvester head, which are usually accommodated directly on the harvester head, should require as little space as possible.

If one intends to make a cut with a chain saw, for instance, for cutting felled trunks of a tree to size, the saw will have to be taken to maximum speed prior to entering the lumber so as to pass through the trunk as quickly as possible at chain speed as high as possible. Since harvesters predominantly harvest smallwood that is sawn through relatively quickly, the time required for powering up the saw to high speed has a noticeable influence on the time required for a cut.

If—given the space available for accommodation—the valve is large enough, the flow rate may be increased in that one has the pressure difference become larger than usual via a metering aperture by influencing, for instance, an individual compensation valve assigned to the distribution valve. The variable displacement pump must, of course, be adjusted or must have been adjusted from the outset such that it also supplies the amount of pressure medium causing the larger pressure difference.

A large amount of pressure medium, i.e. a high speed or rotational frequency of the hydraulic consumer, for instance, the chain saw at the harvester head, and high dynamics, i.e. a quick swiveling out of the variable displacement pump is achieved—in particular also with hydraulic consumers whose load pressure depends on their speed or rotational frequency—if the signaling line to the pump regulator is connected with the supply line to the distribution valve, i.e. a pressure increased vis-à-vis the load pressure, in particular also the pump pressure itself, is reported to the pump regulator.

Such an arbitrary increase of the pressure reported to the LS pump regulator may, for instance, be caused by means of a control arrangement described in DE 199 30 618 A1 or in DE 37 13 824 A1. In these known solutions, for increasing the pressure reported to the LS pump regulator, a separate valve is provided via which the LS line that usually carries the load pressure and that is connected with the LS pump regulator is impacted with the pump pressure, so that the pump, on actuation of the separate valve, goes to maximum pressure and hence a hydraulic consumer may be operated with high dynamics. This means that in these known solutions the corresponding consumer is controlled by a constant pressure system.

It is a disadvantage of this known solution that considerable effort with respect to device technology effort is required since an external valve is necessary for supplying the pump pressure to the LS pump regulator.

### SUMMARY OF THE INVENTION

Contrary to this, it is an object of the invention to provide a hydraulic control arrangement and a distribution valve section by which a hydraulic consumer is controllable with high dynamics.

In accordance with the invention, the hydraulic control arrangement comprises, for supplying pressure medium to hydraulic consumers, a load-sensing variable displacement pump the adjustment of which is modifiable by an LS pump regulator as a function of a signaling pressure in a signaling line. The control arrangement comprises a distribution valve with a valve gate via which a metering aperture is adapted to be controlled, said metering aperture being arranged in the pressure medium flow path between a supply line supplied by the pump and a consumer line leading to the consumer. The signaling line is adapted to be impacted with a signaling pressure that is increased vis-à-vis the load pressure of the consumer by connecting it with the supply line. In accordance with the invention, this is effected in that the signaling line is adapted to be connected with the supply line by shifting the valve gate. The distribution valve section according to the invention which is suited for such a hydraulic control arrangement is designed appropriately.

In this solution, during controlling of the consumer and the adjustment of the pertinent metering aperture involved therewith, a higher pressure than the actual load pressure is signaled to the LS pump regulator, so that the pump is adjusted correspondingly and the pump pressure increases strongly vis-à-vis a solution in which only the current load pressure to the LS pump regulator is signaled, and thus it is possible to control the consumer with high dynamics. The hydraulic control arrangement then possibly operates during the controlling of the consumer as a constant pressure system with an artificially increased pressure signaled to the LS pump regulator. With the sole activation of the other consumers, the hydraulic control arrangement conventionally works as an LS system, wherein the LS variable displacement pump is then controlled as a function of the highest load pressure of these other consumers.

Another advantage of the solution according to the invention consists in that no external valve is required for applying the pump pressure since this application is integrated in the metering aperture assigned to the corresponding consumer.

In accordance with the invention it is preferred if the metering apertures are each formed by a distribution valve of a distribution valve section of a mobile control block, wherein each section has an LS connection adapted to be connected with the pump regulator via the signaling line. In the distribution valve section assigned to the constant pressure consumer, this LS connection is adapted to be connected with the supply line via a signaling channel.

In accordance with the invention it is preferred if an individual compensation valve is assigned at least to the distribution valve of the constant pressure consumer. It is preferably designed as an LS compensation valve that is impacted in opening direction by the pressure in the LS line and the force of a spring, and in closing direction by the pressure upstream of the metering aperture. This LS compensation valve is particularly advantageous if the signaling line is opened after a predetermined opening cross-section of the metering aperture only, so that the consumer is first of all supplied with pressure medium after an LS control, wherein the pressure medium volume flow across the metering aperture is kept constant by the LS compensation valve irrespective of the load pressure and the LS variable displacement pump is controlled as a function of the load pressure of this consumer. As soon as the metering aperture has reached the predetermined opening cross-section, the signaling line is opened and an increased pressure is correspondingly applied to the input of the LS pump regulator, so that the pump pressure increases correspondingly.

In a variant of the invention the LS compensation valve is designed with a load maintaining position in which, in the case of an undersaturation of the pump, it is not possible for the pressure medium volume flow to flow off from the distribution valve section assigned to the consumer.

For limiting the pump pressure, an LS pressure limiting valve used conventionally with LS systems and provided in the LS line may be used.

The control arrangement according to the invention is adapted to be designed in a particularly compact manner if the signaling channel is integrated in a valve gate of the distribution valve.

This integration of the signaling channel in the valve gate may, for instance, be performed in that it branches off from a connecting channel that connects a section of a consumer channel which is situated downstream of the metering aperture with the signaling line. In so doing, the signaling channel branches off between two nozzles, wherein a signaling nozzle is arranged in the signaling channel itself. By the latter nozzle and the nozzle positioned downstream of the metering aperture, a flow splitter is formed at which the higher signaling pressure is tapped.

In an alternative solution, a longitudinal bore of the valve gate is formed in the fluid path to the signaling line in which there opens a radial bore via which a pressure medium communication with the supply line is produced after a predetermined stroke of the valve gate.

A second radial bore of the valve gate may be provided whose opening cross-section is smaller than that of the first radial bore.

The hydraulic control arrangement according to the invention and the method according to the invention may be used in a particularly advantageous manner in mobile hydraulics, for instance, in a harvester head.

The LS distribution valve section in accordance with the invention is designed in correspondence with the foregoing embodiment.

### BRIEF DESCRIPTION OF THE DRAWINGS

In the following, a preferred embodiment of the invention will be explained in more detail by means of schematic drawings. There show:

FIG. 1 a circuit diagram of a first embodiment according to the invention of a hydraulic LS control arrangement for pressure medium supply of a consumer, wherein a pressure splitter of two small nozzles in the bypass to the metering aperture serves to signal an increased pressure;

FIG. 1a the circuit diagram of a variant of the distribution valve of FIG. 1, wherein the pressure directly upstream of the metering aperture is tapped for signaling;

FIG. 2 an embodiment of a hydraulic control arrangement with an LS distribution valve section with an individual compensation valve without load maintenance;

FIG. 3 an embodiment of a hydraulic control arrangement with an LS distribution valve section comprising an individual compensation valve designed with load maintaining function;

FIG. 4 a further embodiment of a hydraulic control arrangement with an LS distribution valve section, wherein, in the case of a small stroke of the control piston of the distribution valve, the load pressure is transmitted to the signaling line, and in the case of a larger stroke an increased pressure is transmitted to the signaling line.

FIG. 5 a concrete solution of the distribution valve section according to FIG. 4; and

FIG. 5a a variant of the solution according to FIG. 5.

### DETAILED DESCRIPTION

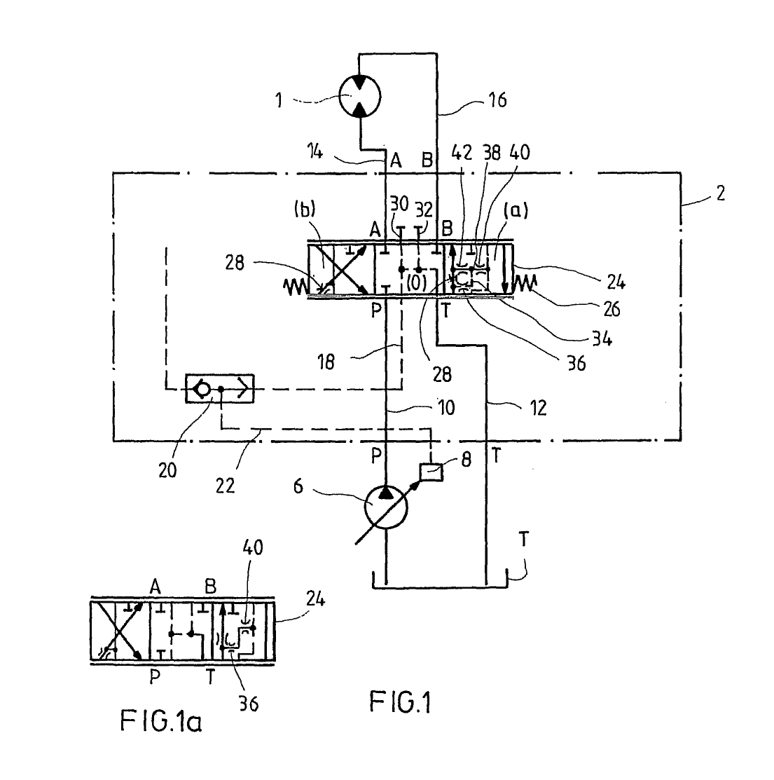

In mobile working equipment, for instance, in a vehicle used in forestry with a harvester head carried on a crane, the pressure medium supply of the individual hydraulic consumers, e.g. of grabs, feed rolls, saws, or the hydraulic cylinders for adjusting the crane, is preferably performed via a plurality of LS mobile control blocks comprising a plurality of distribution valve sections which are each assigned to one of the afore-mentioned consumers. FIG. 1 shows a circuit diagram of a hydraulic control arrangement comprising such a distribution valve section for controlling a hydraulic consumer, for instance, a hydraulic drive of a saw of a harvester head.

In accordance with the hydraulic control arrangement illustrated in FIG. 1, the drive, in the present case a hydro motor 1, is connected, via a distribution valve section 2 of a mobile control block—indicated with a dashed and dotted line—with an LS variable displacement pump 6 and with a tank T. The LS pump 6 may, for instance, be designed as an axial piston pump having a pivoting angle that is adjustable via an LS pump regulator 8. The pressure connection of the variable displacement pump 6 is connected via a supply line 10 with an input connection P of a distribution valve 24 of the distribution valve section 2. The distribution valve 24 further comprises a tank connection T that is connected with the tank T via a drain line 12. Two working connections A, B of the distribution valve 24 are, via a feed line 14 and a return line 16, connected with the supply connection or the drain connection, respectively, of the hydro motor 1. The distribution valve 24 further comprises an LS connection that is connected, via a load signaling line 18 and a two-way valve cascade of which only one two-way valve 20 is illustrated in FIG. 1, with an LS line 22. Via the two-way valve cascade the highest load pressure of all consumers controlled via the mobile control block is tapped and signaled to the LS line 22. The pressure in the LS line 22 is present at the LS pump regulator 8 which adjusts the pivoting angle of the LS variable displacement pump 6 such that a pump pressure ranging by a predetermined Δp, for instance, by 20 bar, over the pressure in the LS line arises.

The continuously variable distribution valve 24 is, via a centering spring arrangement 26, biased in a basic position (0) in which the connections P, A, and B are locked. The load signaling line 18 is in this basic position (0) connected with the drain line 12. Via pilot valves (not illustrated) or via proportional magnets it is possible to shift a valve gate of the distribution valve 24 in the direction of the positions marked with (a).

In these positions the cross-section of the metering aperture 28 between the input connection P and the working connection A and a drain cross-section between the working connection B and the tank connection P are opened, so that pressure medium is adapted to flow, via the feed line 14, to the hydro motor 1 and to flow off to the tank T from the low pressure side thereof via the return line 16 and the distribution valve 24. In these positions (a) the connection to a load signaling chamber 30 which is merely indicated in FIG. 1 is further locked and a load pressure signaling chamber 32 is connected with the load signaling line 18. In the load signaling chamber 32—as will still be explained in the following—an LS pressure limiting valve may be provided for limiting the maximum pressure signaled to the LS pump regulator 8.

In accordance with the illustration in FIG. 1, a signaling channel 34 with a comparatively small cross-section forming a signaling nozzle 36 branches off upstream of the metering aperture 28 in the distribution valve 24. This signaling channel 34 opens in a connecting channel 38 integrated in the valve gate of the distribution valve 24 in the region between two nozzle cross-sections 40, 42. The connecting channel 38 connects a region of the distribution valve 24 which is positioned downstream of the metering aperture 28 with the load signaling line 18. This signaling channel 34 and the portion of the communication channel 38 provided with the nozzle cross-section 42 form a bypass in which the two nozzles 30, 42 form a pressure splitter at which the increased signaling pressure is tapped across the nozzle cross-section 40.

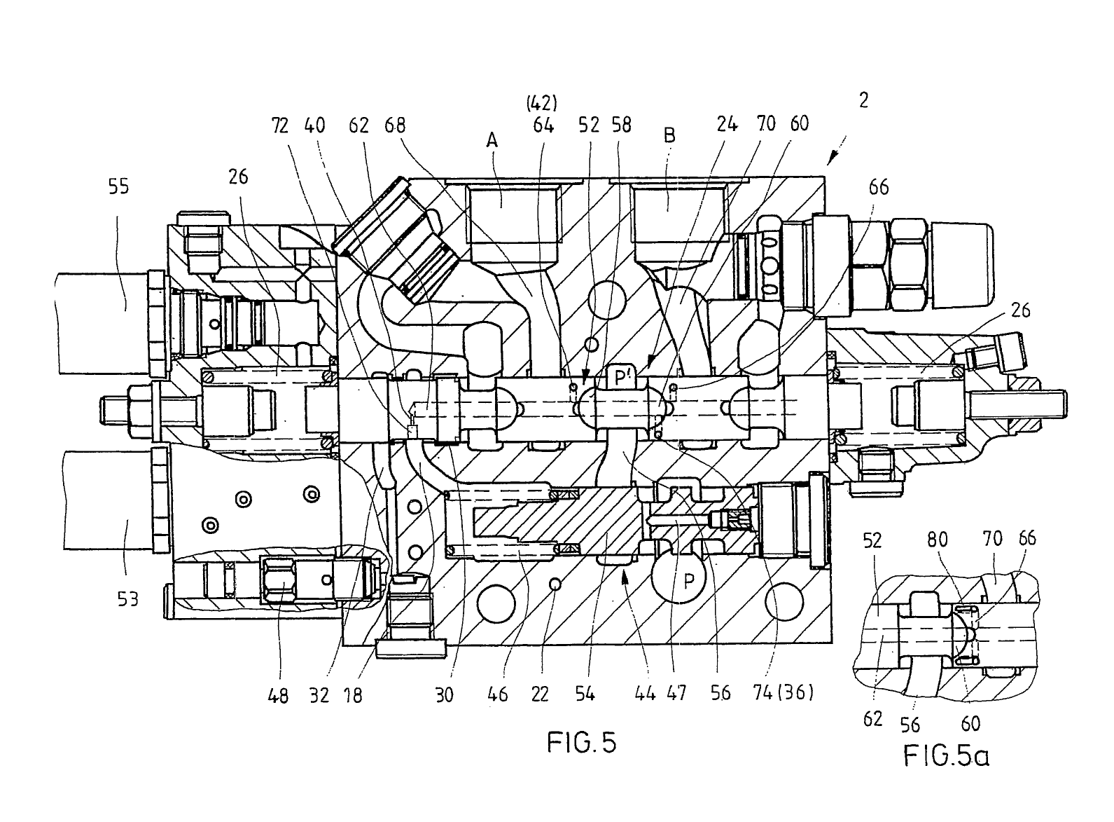

The nozzles 36, 40, and 42 which are, as results from FIG. 5, bores of a small diameter in the control piston, ensure that only small amounts of pressure medium flow through the channels remote from the metering aperture. A small pressure limiting valve is sufficient for limiting the pressure in the channel 18. The losses are small in the case of a response of the pressure limiting function.

For operation of the hydro motor 1, if it drives the chain saw at a harvester head, the distribution valve is usually deflected maximally in the direction of the positions designated with (a). At least in this position the nozzles 36 and 42 are open toward the connection P and the connection A of the distribution valve. Parallel to the metering aperture 28 a small amount of pressure medium flows from P to A via the nozzles 36 and 42. Between the two nozzles a pressure ranging between the pressure in P and the pressure in A will arise which is signaled to the load signaling channel 18 and to the pump regulator 8 via the nozzle 40. This in turn adjusts the pump 6 such that the pressure in P ranges by the pump Δp above the signaled pressure. That means that the pressure drop across the nozzle 36 is equal to the pump Δp. The amount of pressure medium flowing in the bypass to the metering aperture results from the flow rate cross-section of the nozzle 36 and the pressure drop across this nozzle, i.e. the pump Δp. This amount of pressure medium also flows over the nozzle 42 and generates a pressure drop which depends on the flow rate cross-section thereof. By selecting the flow rate cross-section of the nozzle 42 vis-à-vis the flow rate cross-section of the nozzle 36 it is thus possible to determine by how much the signaled pressure ranges above the pressure in A. If, for instance, the flow rate cross-section of the nozzle 42 is as large as the flow rate cross-section of the nozzle 26, the signaled pressure ranges by the pump Δp above the pressure in A. The variable displacement pump will then be adjusted to such a delivery rate (normal delivery rate without nozzle 36 multiplied by the root of 2) that it generates a pressure drop across the metering aperture 28 which is twice as large as the pump Δp. The variable displacement pump is, due to the pressure signaled to be increased vis-à-vis the load pressure in the connection A of the distribution valve, quickly adjusted to a high delivery rate, possibly to the maximum delivery rate, if this maximum delivery rate does not yet generate the pressure drop provided by the pump Δp and the flow rate cross-sections of the nozzles 36 and 42 via the metering aperture 28. The pump would remain below the maximum delivery rate if the pressure regulator with which an LS variable displacement pump is usually also equipped for maximum pressure safeguarding, or a pressure limiting valve connected to the load pressure signaling lines 18 or 22 would respond.

In the variant of the distribution valve 24 pursuant to FIG. 1a, being a marginal case of the variant pursuant to FIG. 1, the nozzle 42 of FIG. 1 is missing. Here, exactly the pressure in the connection P of the distribution valve, i.e. the pump pressure across the nozzles 36 and 40, is signaled to the load signaling channel 18 unless a pressure limiting valve that responds is connected to the channel 18 or 22. If such a pressure limiting valve does not exist, the two nozzles are not necessary. If a pressure limiting valve exists, either of the two nozzles is in principle sufficient. To the extent that both are available, they will add up in their effect. Even if they are not necessary here, they were plotted if they constitute flow rate cross-section constrictions in the constructional design vis-à-vis the other LS fluid path sections.

If, as in the variant pursuant to FIG. 1a, the bypass to the metering aperture 28 is missing, the pump swivels out to maximum delivery rate very quickly since the pump pressure is signaled to the LS pump regulator, unless the pressure cut-off of the pump regulation will apply before or a pressure limiting valve connected to an LS line will respond.

If the distribution valve 24 is shifted to the positions marked with (b), the metering aperture 28 positioned between the input connection P and the working connection B will be opened and the pressure medium communication from the working connection A to the tank T will be opened, so that the hydro motor 1 is adapted to be driven with inverse direction of rotation. In these positions, the actual load pressure is tapped downstream of the metering aperture 28 and is signaled via the load signaling line 18, the two-way valve 20, and the LS line 22 to the LS pump regulator 8, so that the adjustment of the pump is performed as a function of the actual load pressure. On principle, however, the pump pressure may be signaled to the pump regulator 8 via a channel corresponding to the signaling channel 34 even if the distribution valve 24 is shifted in the direction (b), so that the pressure medium supply of the hydro motor 1 is also effected as a function of the pump pressure.

The control arrangement illustrated in FIG. 1 is preferably used if very large amounts of pressure medium are intended to flow over the distribution valve section 2.

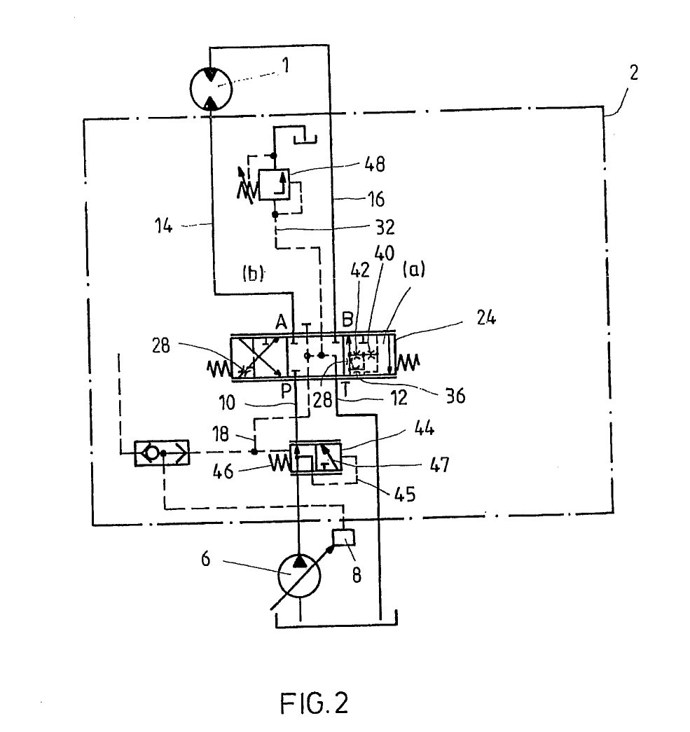

FIG. 2 shows a variant of the control arrangement of FIG. 1, wherein the basic structure is substantially identical, so that only the differences with respect to FIG. 1 are explained. For the rest, the same reference numbers are used for components corresponding to each other, and reference is made to the corresponding description of FIG. 1.

In the control arrangement illustrated in FIG. 2, the distribution valve section 2 is designed with an LS compensation valve 44 positioned in the pressure medium flow path between the LS variable displacement pump 6 and the distribution valve 24 in the supply line 10. The LS compensation valve 44 is impacted in closing direction via a control line 45 by a pressure upstream of the metering aperture 28 and downstream of the opening cross-section of the LS compensation valve 44, and in opening direction by the force of a spring 46 and by the pressure in the load signaling line 18.

In the case of a shifting to the positions designated with (a), the pressure existing between the nozzles 36 and 42 via the nozzle 40 and the load signaling line 18 is present at the control face of the compensation valve control piston which is effective in opening direction. The pressure upstream of the metering aperture 28 is, corresponding to the force of the spring 46, higher than the pressure acting on the opening side of the compensation valve 44, so that here, too, a large pressure drop across the metering aperture 28 is possible.

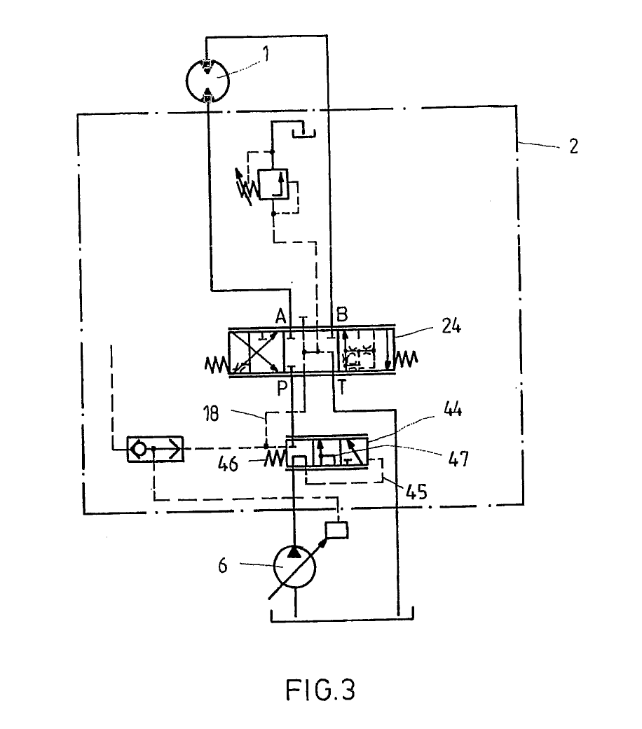

FIG. 3 shows a variant of a control arrangement which differs from the embodiment pursuant to FIG. 2 merely in that the LS compensation valve 44 is designed with a load maintaining function. The compensation valve piston thereof is again impacted by the spring 46 and the pressure in the load signaling line 18 in opening direction and in closing direction, unless in load maintenance, by the pressure in the pressure medium flow path downstream of the opening cross-section of the LS compensation valve 44 and upstream of the LS distribution valve 24. This pressure is tapped within the LS compensation valve 44 via a compensation valve piston bore 47 and is applied to the—in FIG. 3—right control face of the compensation valve piston. In the case of an uncontrolled LS variable displacement pump 6 or in the case in which the LS variable displacement pump 6 has not yet built up the pressure necessary for maintaining a load after the opening of the distribution valve, the LS compensation valve 44 is maintained in the illustrated load maintaining position or taken to this position by the force of the spring 46 and the pressure in the load signaling line 18, so that the pressure medium cannot flow off from the supply side of the hydro motor 1 over the controlled distribution valve 24. As for the rest, the embodiment illustrated in FIG. 3 corresponds to that of FIG. 2, so that further explanations are dispensable.

The control arrangements pursuant to FIGS. 2 and 3 are preferably used if the maximum pressure medium volume flow is not always required for actuating the consumer, but if at least in particular stroke regions of the distribution valve a load-independent control of the hydraulic consumer is intended to be possible. It is possible to choose the position of the signaling channel 34 such that it is first of all closed and is opened only after a predetermined stroke of the distribution valve gate. During this partial stroke the LS distribution valve section 2 then operates in a conventional manner pursuant to an LS control with a small pressure difference across the metering aperture 28, wherein first of all the load pressure at the controlled consumer is signaled to the spring chamber of the LS compensation valve 44. As the valve gate is further shifted, the higher pressure is signaled to the LS pump regulator.

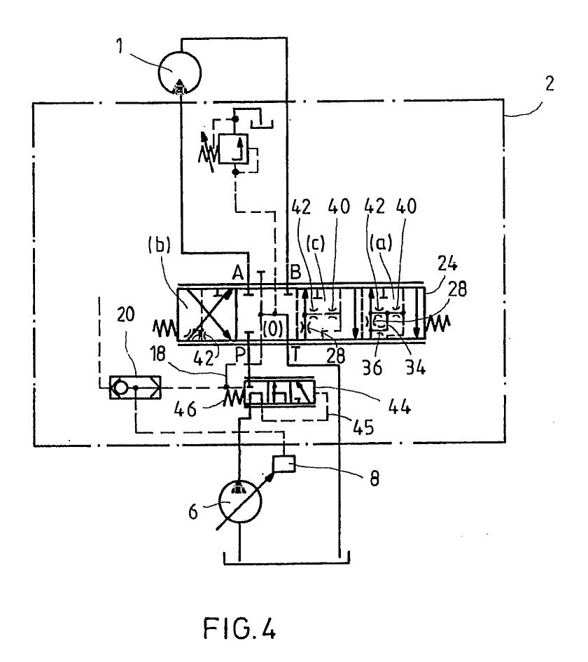

The circuit diagram of such an embodiment of a control arrangement with a so-called booster function is illustrated in FIG. 4. The only difference vis-à-vis the embodiment according to FIG. 3 consists in that, in the case of a shifting in the direction (a) of the distribution valve (24), the signaling channel 34 is first of all not opened in intermediate positions (c). The metering aperture 28 is opened in these intermediate positions with a comparatively small cross-section. The pressure downstream of the metering aperture 28 which corresponds to the load pressure is tapped across the two nozzle cross-sections 42, 40. Accordingly, first of all the load pressure acts via the LS connection of the distribution valve 24 and the load signaling line 18 in the opening direction on the LS compensation valve 44, so that the pressure drop across the metering aperture 28 corresponds to the force of the spring and thus the load pressure is independently maintained constant. The variable displacement pump 6 is adjusted as a function of this load pressure.

During the further shifting of the distribution valve 24, the positions designated with (a) are reached in which the signaling channel 34 with the signaling nozzle 36 is opened in the afore-described manner, so that the pressure prevailing between the two nozzles 36 and 42 is present in the load signaling line 18 and hence in the spring chamber of the LS compensation valve 44 and at the LS pump regulator 8, so that the variable displacement pump 6 swivels out further and a high pressure medium volume flow is supplied to the hydro motor 1. If the cross-section of the nozzle is substantially larger than the cross-section of the nozzle 42, the pump pressure is practically signaled to the LS pump regulator, so that the pump changes to maximum delivery rate.

As for the rest, the embodiment illustrated in FIG. 4 corresponds to the afore-described embodiment, so that further explanations are dispensable.

FIG. 5 shows a concrete embodiment of the distribution valve section 2 of FIG. 4. The basic structure of this distribution valve section 2 is known from prior art, for instance, form the applicant's data sheet RD 64 282, so that only the essential function features will be described here. The concrete distribution valve section 2 is designed in disc construction and comprises a valve gate 52 that contributes to the design of the distribution valve 24 and that is biased in its basic position through the centering spring arrangement 26 and that is adapted to be shifted in the direction of the positions designated with (a) or (b) by means of the pilot valves 53, 55 that are, for instance, designed as pressure reducing valves. The LS compensation valve 44 is positioned upstream of the distribution valve 24, the control piston 54 thereof being biased in the illustrated load maintaining position by the force of the spring 46. In this position, the pressure medium communication from a pressure connection P to a communication channel 56 extending between the input of the distribution valve 24 and the output of the LS compensation valve 44 is blocked. The pressure downstream of the control edge of the LS compensation valve 44 is tapped via the compensation valve bore 47 penetrating the control piston 54 and acts on the—in FIG. 4—right front face of the control piston 54.

In the illustrated basic position the valve gate 52 of the distribution valve 24 blocks the pressure medium communication between the communication channel 56 carrying the pressure P′ downstream of the LS compensation valve 44 and the two working connections A, B of the distribution valve section 2. On controlling of either of the pilot valves 53, 55 the pressure medium communication to the hydro motor 1 is opened or closed, respectively, in the afore-described manner via control grooves 58 or 60, respectively. The load pressure present at the working connections A, B, i.e. the pressure downstream of the metering aperture 28 opened by the control edge 58 or 60 (see FIG. 4), is tapped via a longitudinal bore 62 and small radial bores 64, 66 of the valve gate 52. The two radial bores 64 or 66, respectively, each form the nozzle cross-section 42 pursuant to FIG. 4. These small radial bores 64 or 66, respectively, open in the case of the shifting of the distribution valve 24 depending on the direction of shifting in the channels 68, 70 connected with the connections A, B and forming a part of the feed/return line 14 or the return/feed line 16, respectively. The load pressure that is then present in the longitudinal bore 62 is, via a small radial bore section 72 in which the nozzle cross-section 40 of FIG. 4 is formed, and an arcuate channel forming the load signaling line 18, signaled to the spring chamber of the LS compensation valve 44, so that the control piston 54 is correspondingly impacted with the load pressure in opening direction (with respect to the regular position). This load pressure is also present at the pump regulator 8. In the illustrated distribution valve section 2, the maximum load pressure may be limited by the LS pressure limiting valve 48 connected to the load signaling chamber 32.

To this extent, the structure of the distribution valve section 2 corresponds completely to the known solution. In the embodiment according to the invention, this known distribution valve section 2 has been modified such that, after a predetermined stroke of the valve gate 52 in terms of a communication of the channel 68 with the channel 56, at least one further radial bore 74 of the valve gate which opens in the longitudinal bore 62 at the inside is opened toward the channel 56. The radial bore 64 that forms, in the viewed actuation direction of the valve gate, the nozzle 42 of FIG. 4, was opened toward the channel 68 before already. Thus, the bypass comprising the two nozzles 36 and 42 is now opened toward the metering aperture 28 formed at the control edge 58 of the valve gate. The pressure prevailing between the two nozzles which is increased vis-à-vis the load pressure is signaled to the compensation valve 44 and to the pump regulator 8. The radial bore 74 forms the nozzle 36 of FIG. 4.

To increase the cross-section of the nozzle 36, further radial bores positioned in the same radial plane may be distributed around the circumference of the valve gate. Ultimately, the pressure in the longitudinal bore 62 will be almost equal to the pressure in the channel 56.

In the case of a small stroke of the valve gate 52 (positions (c)), a sensitive controlling of the consumer is thus possible, while during further shifting to the positions (a) the consumer is supplied with a high pressure medium volume flow. If the sensitivity is not required, the bore 68 may be dispensed with. With one single small bore 74 it is then possible to take the pressure from the channel 56 to the longitudinal bore 62.

In the illustrated distribution valve section 2, the maximum load pressure may be limited by the LS pressure limiting valve 48 connected to the load pressure signaling chamber 32.

In the case of a shifting in the direction (b), the radial bore 74 remains closed vis-à-vis the channel 56. In a conventional manner, the load pressure at the working connection B is signaled via the bore 66 to the spring chamber of the LS compensation valve 44 and to the pump regulator 8. On principle, however, a second signaling bore might be effective then, so that the LS variable displacement pump 6 is also shifted in direction (b) in terms of an increase of the pressure medium volume flow.

With the distribution valve of FIG. 5 it is important that the longitudinal bore 62 is, in the case of a shifting of the valve gate 52 in terms of a communication of the connection A with the channel 56, connected with this channel 56, and in the case of a shifting of the valve gate in terms of a communication of the connection B with the channel 56, connected with the channel 70. This may, as is shown by the variant pursuant to FIG. 5a, also be achieved by one single radial bore and an axially closed longitudinal groove 80 in the outer face of the valve gate 52 which is open toward the radial bore. Pursuant to FIG. 5a, the radial bore is the standard radial bore 66 via which the pressure is tapped in the connection B. The longitudinal groove extends from the radial bore 66 between two fine control grooves 60 of the valve gate 52 in the direction of the front face thereof facing the channel 56.

If the valve gate 52, viewed pursuant to FIG. 5a, is shifted to the left from the center position shown, the longitudinal groove 80 opens toward the channel 56 after a particular stroke. Thus, the longitudinal bore 62 of the valve gate is connected with the channel 56. In the case of a shifting of the valve gate from its center position in the opposite direction, the longitudinal bore 62 is, after a shorter stroke, connected with the channel 70 and thus with the connection B. In the variant pursuant to FIG. 5a the idea according to the invention is thus implemented in a very simple manner, wherein it is not necessary to take care in a difficult manner that a radial bore cuts the fine control grooves 60. Two radial bores 66 and longitudinal grooves 80 may be distributed around the circumference of the valve gate 52, as is shown in FIG. 5a. This is based on symmetric aspects. With respect to the cross-section, one bore 66 and one longitudinal groove 80 are in principle sufficient since no bore 68 is available in the variant pursuant to FIG. 5a. To this extent, this variant corresponds to the circuit diagram of FIG. 1a.

A hydraulic control arrangement and a method for pressure medium supply of hydraulic consumers are disclosed, comprising an LS pump which can be controlled by a pump regulator dependent on the highest load pressure of the consumers. The pressure medium volume flow to each consumer is adjusted using a metering aperture, wherein on controlling a consumer a higher pressure than the load pressure is signaled to the LS pump regulator, so that the LS pump is controlled according to the higher pressure rather than the low load pressure of said consumer.

### LIST OF REFERENCE SIGNS

1 hydro motor
2 distribution valve section
6 LS variable displacement pump
8 LS pump regulator
10 supply line
12 drain line
14 feed line
16 return line
18 signaling line
20 two-way valve
22 LS line
24 distribution valve
26 centering spring arrangement
28 metering aperture
30 load signaling chamber
32 load signaling chamber
34 signaling channel
36 signaling nozzle
38 connecting channel
40 nozzle cross-section
42 nozzle cross-section
44 LS compensation valve
45 control line
46 spring
47 compensation valve piston bore
48 LS compensation valve limiting valve
50 channel
52 valve gate
53 pilot valve
55 pilot valve
54 control piston
56 communication channel
58 control groove
60 control groove
62 longitudinal bore
64 radial bore
66 radial bore
68 channel
70 channel
72 radial bore section
74 signaling bore
80 longitudinal groove

1. A hydraulic control arrangement for pressure medium supply of a plurality of hydraulic consumers, comprising a load-sensing variable displacement pump (6), the adjustment of which is modifiable as a function of a signaling pressure present in a signaling line (18) by an LS pump regulator (8), a distribution valve (24) comprising a valve gate (52) in a valve bore, by means of which an opening cross-section of a metering aperture (28) positioned in a fluid path between a supply line (10) supplied by the pump (6) and a consumer line (14) leading to a consumer (1) can be controlled, wherein said signaling line (18), by connecting it with the supply line (10), is adapted to be impacted with an increased signaling pressure vis-à-vis the load pressure of said one consumer (1), characterized in that said signaling line (18) is adapted to be connected with said supply line (10) by shifting the valve gate (52) of said distribution valve (24).

2. The hydraulic control arrangement according to claim 1, wherein the metering apertures (28) assigned to said consumers (1) are each formed by a distribution valve (24) of a distribution valve section (2) of a mobile control block, wherein each distribution valve (24) comprises an LS connection which is connected with said LS pump regulator (8) via said signaling line (18) and which is adapted to be connected via a signaling channel (34) with said supply line (10) in said distribution valve (24) assigned to said one consumer (1).

3. The hydraulic control arrangement according to claim 1, wherein an individual compensation valve (44) is assigned to at least said distribution valve (24) of said one consumer (1).

4. The hydraulic control arrangement according to claim 3, wherein said individual compensation valve is an LS compensation valve (44), and wherein said signaling line (18) is adapted to be connected with said supply line (10) between said compensation valve (44) and said metering aperture (28).

5. The hydraulic control arrangement according to claim 2, wherein said signaling channel (34) is adapted to be opened only from a particular opening of said metering aperture (28) on, and wherein in the intermediate region said LS connection is connected with a region positioned downstream of said metering aperture (28).

6. The hydraulic control arrangement according to claim 3, wherein said individual compensation valve (44) is designed with a load maintaining position in which the pressure medium communication between said consumer (1) and said LS variable displacement pump (6) is blocked.

7. The hydraulic control arrangement according to claim 1, comprising an LS pressure limiting valve (48) for limiting the pressure present at said LS pump regulator (8).

8. The hydraulic control arrangement according to claim 2, wherein said signaling channel (34) is substantially integrated in a valve gate (52) of said distribution valve (24).

9. The hydraulic control arrangement according to claim 8, wherein a longitudinal bore (62) of said valve gate (52) is positioned in the fluid path to said signaling line (18), and wherein said valve gate (52) comprises at least one first radial bore (74) that is open inside toward said longitudinal bore (62), said radial bore (74) being opened, after a particular stroke of said valve gate (52), from the center position in the one direction toward a section (56) of said supply line (10) which opens in the valve bore in which the valve gate is positioned.

10. The hydraulic control arrangement according to claim 9, wherein in the case of a shifting of said valve gate (52) in the one direction, at least a second radial bore (64) of said valve gate which is open inside toward said longitudinal bore (62) is opened toward the supplied consumer channel (68), and wherein the entire flow rate cross-section of said at least one first radial bore (74) is substantially larger than the flow rate cross-section of said second radial bore (64).

11. The hydraulic control arrangement according to claim 8, wherein said signaling channel (34) branches off from a communication channel (38) connecting a section of a consumer channel (14) which is positioned downstream of said metering aperture (18) with said signaling line (18), wherein said signaling channel (24) branches off between two nozzles (40, 42), and wherein a signaling nozzle (36) is positioned in said signaling channel (24).

12. The hydraulic control arrangement according to claim 1, wherein said consumer is an assembly of a harvester head.

13. An LS distribution valve section for controlling a consumer (1), comprising a valve gate (52) guided in a valve bore by means of which an opening cross-section of a metering aperture (28) can be controlled, said metering aperture (28) being positioned in a fluid path between a pressure connection (P) connected with a supply line (10) and a consumer connection (A) connected with a consumer channel (14), and a signaling line (18) via which a signaling pressure is adapted to be applied to an LS connection, characterized in that said signaling line (18) is adapted to be connected with a fluid path between said pressure connection (P) and said metering aperture (28) by shifting said valve gate (52).

14. The LS distribution valve section according to claim 13, wherein a longitudinal bore (62) of said valve gate (52) is positioned in the fluid path to said signaling line (18), and wherein said valve gate (52) comprises at least one first radial bore (74) that is open inside toward said longitudinal bore (62), said radial bore (74) being opened after a particular stroke of said valve gate (52) from the center position in the one direction to a section (56) of said supply line (10) which opens in said valve bore in which said valve gate is positioned.

15. The LS distribution valve section according to claim 14, wherein in the case of a shifting of said valve gate (52) in the one direction at least a second radial bore (64) of said valve gate which is open inside toward said longitudinal bore (62) is opened toward the supplied consumer channel (68), and wherein the entire flow rate cross-section of said at least one first radial bore (74) is substantially larger than the flow rate cross-section of said second radial bore (64).
